(19) United States
(12) Patent Application Publication
(10) Pub. No.: US 2013/0298047 A1
(43) Pub. Date: Nov. 7, 2013

(54) Previewing and Editing Web Sites with a Different User Roles, Identifiers and Authorization Level

(71) Applicants: Dieter Buehler, Tuebingen (DE); Jon M. Harris, Raleigh, NC (US); Stefan A. Hepper, San Jose, CA (US); Carsten Leue, Sindelfingen (DE); Stefan Schmitt, Holzgerlingen (DE); Jeffrey L. Sokolov, Lexington, MA (US)

(72) Inventors: Dieter Buehler, Tuebingen (DE); Jon M. Harris, Raleigh, NC (US); Stefan A. Hepper, San Jose, CA (US); Carsten Leue, Sindelfingen (DE); Stefan Schmitt, Holzgerlingen (DE); Jeffrey L. Sokolov, Lexington, MA (US)

(73) Assignee: INTERNATIONAL BUSINESS MACHINES CORPORATION, Armonk, NY (US)

(21) Appl. No.: 13/462,894

(22) Filed: May 3, 2012

(51) Int. Cl. G06F 3/01; G06F 15/16

(52) U.S. Cl. 715/760

(57) ABSTRACT

Methods and systems may involve establishing a web portal session with a user of a web content management tool, and generating a user interface in the web content management tool during the web portal session. In one example, the user interface includes a page view and a content editing view. Additionally, the user interface may be transitioned between a page edit state and a page preview state while maintaining the web portal session with the user.

### BACKGROUND

Embodiments of the present invention generally relate to the development of web portals. More particularly, embodiments relate to editing and previewing web portals with multiple user roles and authorization levels.

Web portals may be used in a wide variety of settings to provide users with access to information, online transactions and other functionality. While conventional web portal authoring tools may be acceptable under certain circumstances, there remains considerable room for improvement. For example, in order to view the page content of a portal as a typical user would, it may not be uncommon for the authoring tool to require the authoring session to be ended so that the author can log back into the tool and impersonate the user. Such an approach can be time consuming, inconvenient to the author, and may even lead to increased development costs. Moreover, certain web portals may display pages differently depending upon personalization settings (e.g., gold customer versus platinum customer), user identity (e.g., manager versus assistant), authentication status (e.g., authenticated versus non-authenticated), and so forth, wherein conventional impersonation techniques may fail to address the editing complexities presented by such differences.

### BRIEF SUMMARY

Embodiments may include a computer program product having a computer readable storage medium and computer usable code stored on the computer readable storage medium. If executed by a processor, the computer usable code may cause a computer to establish a web portal session with a user of a web content management tool, and generate a user interface in the web content management tool during the web portal session, wherein the user interface is to include a page view and a content editing view. The computer usable code, if executed, may also cause a computer to transition the user interface between a page edit state and a page preview state while maintaining the web portal session with the user.

Embodiments may also include a computer implemented method of operating a web content management tool in which a web portal session is established with a user of the web content management tool. The method may also provide for generating a user interface in the web content management tool during the web portal session, wherein the user interface includes a page view and a content editing view. In addition, one or more user selections can be received via the user interface, wherein an author identifier and a previewer identifier may be identified based on the user selections. Moreover, the method may provide for transitioning the user interface between a page edit state and a page preview state while maintaining the web portal session with the user. In one example, transitioning the user interface includes encoding a toolbar request into a first uniform resource locator (URL). State information, and one or more of an author identifier and a previewer identifier may be encoded into a second URL, wherein the first and second URLs can be transmitted to an application server. In addition, an updated content editing view may be received from the application server. Additionally, an updated page view may be received from the application server, wherein the updated page view is dependent upon the state information and one or more of the author identifier and the previewer identifier. The method may also provide for displaying the updated page view and the updated content editing view in the user interface.

Embodiments may also include a computer program product having a computer readable storage medium and computer usable code stored on the computer readable storage medium. If executed by a processor, the computer usable code may cause a computer to establish a web portal session with a client device, transmit a page view and a content editing view to the client device, and receive a first URL and a second URL from the client device. The computer usable code, if executed, may also cause a computer to decode the first URL , decode the second URL to identify state information, and one or more of an author identifier and a previewer identifier, generate an updated content editing view based on the toolbar request, and generate an updated page view based on the state information and one or more of the author identifier and the previewer identifier. Moreover, the computer usable code, if executed, can cause a computer to transmit the updated content editing view and the updated page view to the client device, wherein the updated content editing view and the updated page view are to correspond to a transition of a web content management tool interface between a page edit state and a page preview state while the web portal session is maintained with the client device.

### BRIEF DESCRIPTION OF THE SEVERAL VIEWS OF THE DRAWINGS

The various advantages of the embodiments of the present invention will become apparent to one skilled in the art by reading the following specification and appended claims, and by referencing the following drawings, in which:

FIGS. 1A-1D are block diagrams of examples of user interfaces according to embodiments;

FIGS. 2A and 2B are flowcharts of examples of methods of operating a web content management tool according to embodiments;

FIG. 3 is a flowchart of an example of a method of operating an application server according to embodiments;

FIG. 4 is a block diagram of an example of a networking architecture according to an embodiment; and

FIG. 5 is a signaling diagram of an example of an approach to previewing pages with different user identifiers according to an embodiment.

### DETAILED DESCRIPTION

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

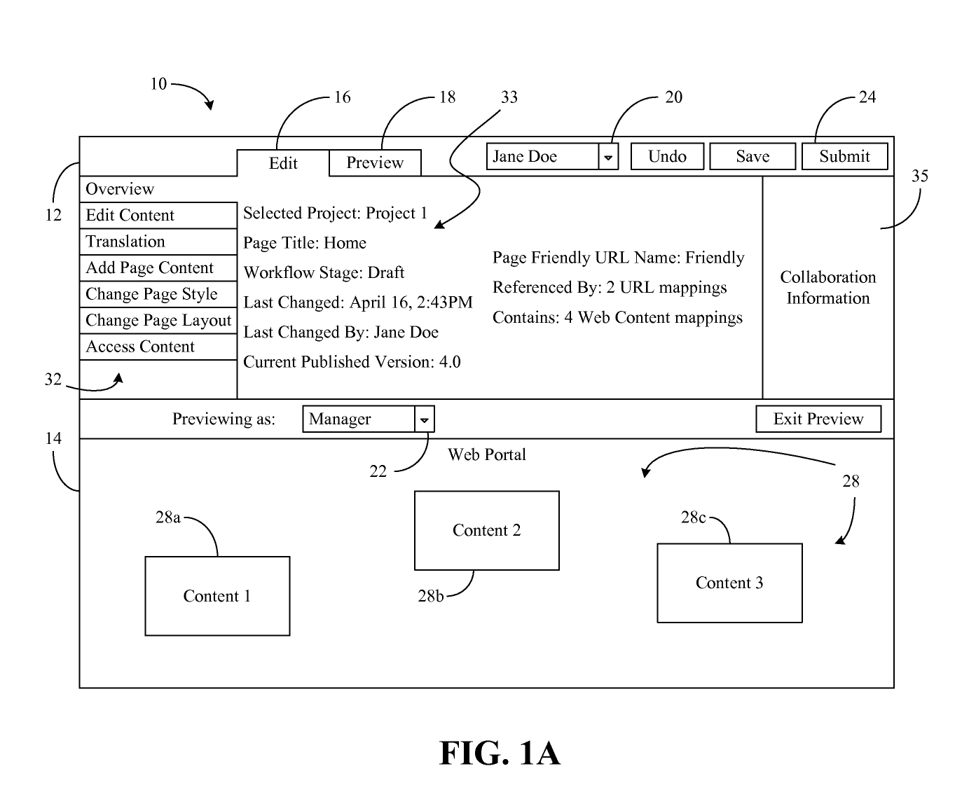

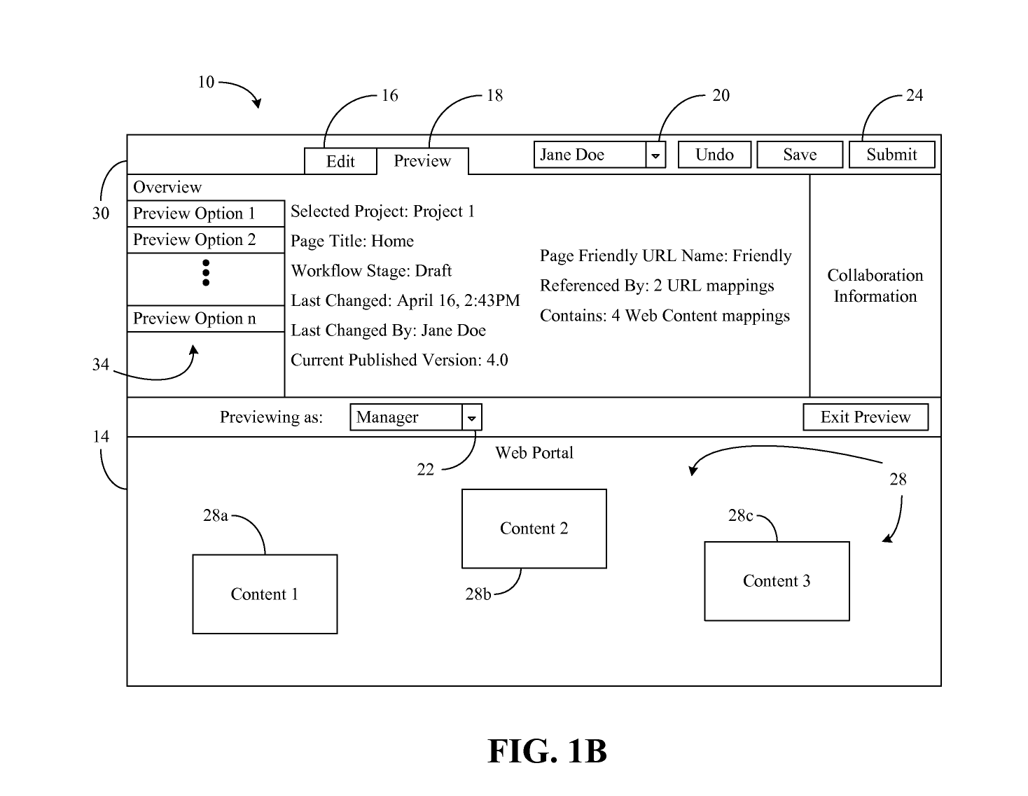

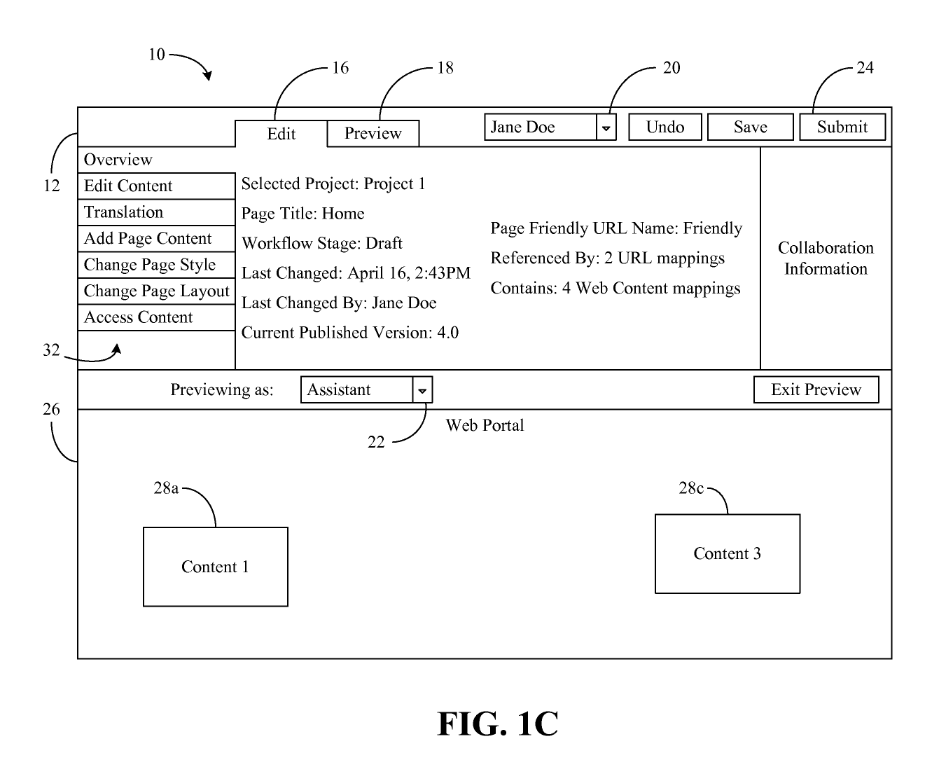

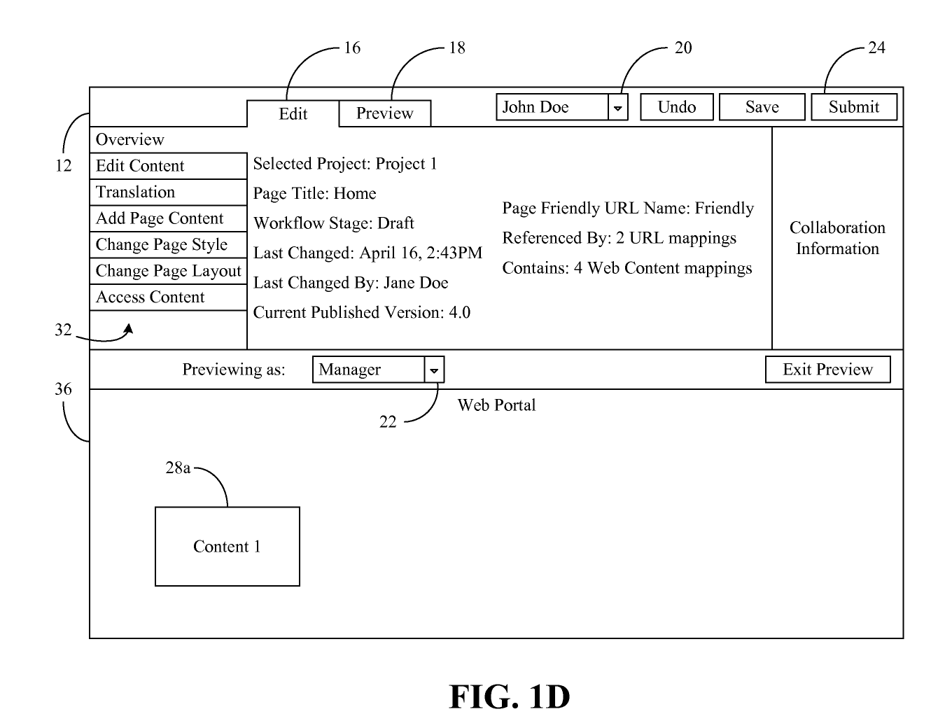

Referring now to FIGS. 1A-1D, a user interface (UI) 10 of a web content management tool is shown. The illustrated UI 10 generally includes a content editing view 12 (e.g., toolbar iframe instance) and a page view 14, wherein the page view 14 includes page content 28 (28a-28c) and the content editing view 12 includes one or more authoring options 32, project data 33 and collaboration information 35. The illustrated authoring options 32 enable the user to conduct various web portal authoring activities such as editing content, translating content, adding and/or deleting content, changing page styles, changing page layouts, and so forth. The project data 33 may be used to track page authoring statistics such as, for example, version information, workflow stage, etc. The illustrated collaboration information 35 might contain more detailed information regarding the authors/individuals (e.g., users) working on the web portal development project.

In the illustrated example, the content editing view 12 and the page view 14 can be transitioned between a page edit state and a page preview state while maintaining a single web portal session with a user of the UI 10. More particularly, selecting an edit tab 16 in the content editing view 12 may place the UI 10 in the page edit state, and selecting a preview tab 18 may place the UI 10 in the page preview state. Thus, the illustrated content editing view 12 of FIG. 1A is in the page edit state, whereas the page preview state shown in FIG. 1B demonstrates that selecting the preview tab 18 may cause an updated content editing view 30 to be retrieved, wherein the updated content editing view 30 can include one or more previewing options 34.

As will be discussed in greater detail, the transition between the page edit state and the page preview state can be accomplished by encoding certain information into one or more uniform resource locator (URL) requests associated with the UI 10, wherein the encoded information can instruct a remote application server as to how to conduct the transition. For example, if a supervisory user “Jane Doe” selects the preview tab 18 (FIG. 1B), her name from a drop down menu 20, the previewing role of “Manager” from a drop down menu 22, and then a submit button 24, the content management tool may in turn encode a toolbar request into a first URL for the content editing view 12 and encode additional state and identifier information into a second URL for the page view 14. The content management tool may then transmit the first and second URLs to the application server as one or more web requests. More particularly, the page preview state and the author identifier “Jane Doe” may be encoded into the second URL in order to instruct the remote server on how to respond. Thus, the second URL might include, for example, “ . . . portal.xyz.com/mode=preview/author_janedoe/pageA”, wherein the first URL could include “portal.xyz.com/mode=toolbar/pageA” as a shortened version of a full page URL. The content management tool may also encode “Manager” as a preview identifier into the second URL for the page view 14. In such a case, the term “previewer_manager” might be substituted for, or added to, the term “author_janedoe” in the above example of the second URL.

Transitions between the page preview state and the page edit state may therefore be readily accomplished by encoding the appropriate state and identifier information into the transmitted URLs. For example, if, on the other hand, the user selects the edit tab (FIG. 1A), the content management tool may encode the page edit state (e.g., “mode=edit”) into the second URL in the example immediately above. Other approaches and/or protocols to encoding the state and identifier information may also be used. The application server may decode the URLs, determine the state and identifier information, and generate updated views accordingly.

Of particular note is that the updated views in the UI 10 may be dependent upon the information encoded into the requested URLs without ending the original web portal session. For example, FIG. 1C demonstrates that an updated page view 26 may be dependent upon the previewer identifier. In the illustrated example, the previewing role of “Assistant” has been selected from the drop down menu 22, wherein the content 28b is no longer visible. Thus, the content 28b might correspond to sensitive subject matter, such as human resources content, or be related to some other personalization rule/profile (e.g., customer level). As will be discussed in greater detail, the application server may be configured to automatically tailor the returned web content to the selected previewing role. In such a case, the previewer's authentication level (but not authentication credentials) may also be encoded into the second URL to give the application server further guidance as to how to generate the page content. Moreover, such functionality may be accomplished without impersonating the selected previewing role, which could otherwise require an authentication infrastructure (e.g., chip cards, certificates) that may be unavailable to the author (e.g., Jane Doe) at the time of development.

Another example may be a step-up authentication in which the authentication level is increased to provide access to additional content in the page view. In still another example, the previewer identifier can be toggled between “authenticated previewer” and “unauthenticated previewer”. Such a case may be useful in determining and designing the page content that will be displayed in the event that user authentication into the web portal is unsuccessful.

In yet another example, FIG. 1D demonstrates that an updated page view 36 may be dependent upon the author identifier. In particular, the author “John Doe” might be selected from the drop down menu 20 (e.g., manually, automatically via login process, etc.), wherein John Doe could have a relatively low level of authorization (e.g., intern versus the supervisor Jane Doe). In such a case, the application server may configure the updated page view 36 to contain only the content 28a, wherein both the content 28b (FIG. 1A) and the content 28c (FIG. 1A) could be hidden from view due to security concerns.

The content editing view 12 can be similarly tailored to the particular identifier information encoded into the URLs. In such a case, authentication information associated with the selected author identifier (e.g., John Doe's login credentials) may also be encoded into the first URL, wherein the application server may use the authentication information to determine whether the user is authorized to view certain page content. Simply put, both the page views and the content editing views may be dependent upon the state information, the previewer identifiers, the previewer authentication levels, the author identifiers, and the author authentication information, depending upon the circumstances.

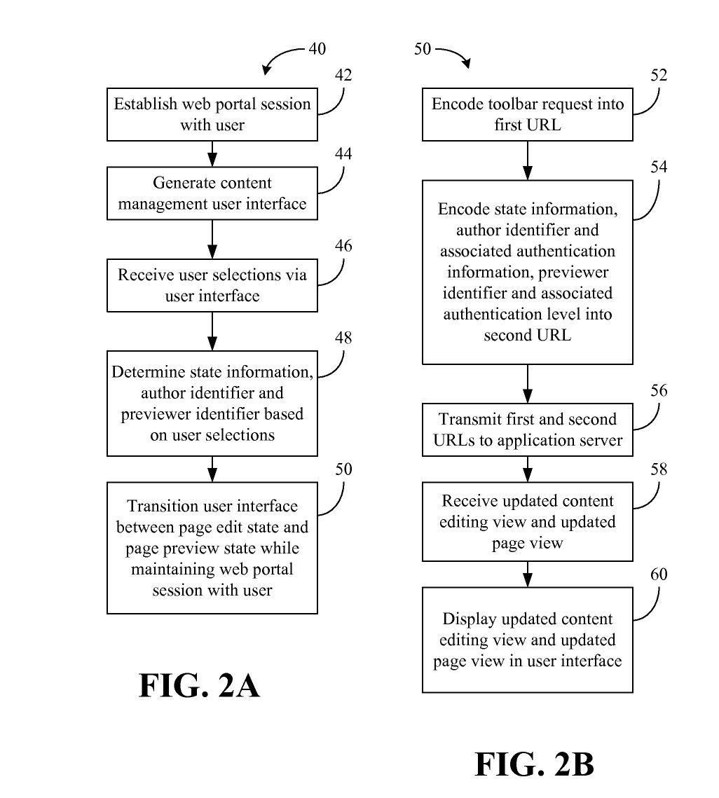

Turning now to FIG. 2A, a method 40 of operating a web content management tool is shown. Illustrated processing block 42 provides for establishing a web portal session with a user of the web content management tool, wherein a user interface (UI) may be generated in the web content management tool at block 44. As already discussed, the UI can include a page view, a content editing view, and so forth. One or more user selections may be received at block 46 via the UI, wherein illustrated block 48 determines state information, an author identifier, and a previewer identifier based on the user selections. For example, the state information may reflect whether a page edit tab, a page preview tab, and/or various options within those tabs have been selected. Moreover, the state information can contain edits made to the page content, collaboration information, and other project related data. The author identifier may correspond to an individual making edits and/or revisions to the web portal via the content management tool, wherein the previewer identifier may correspond to an individual or classification of individual (e.g., manager, assistant, gold customer, platinum customer) who may interact with the web portal. Block 50 may provide for transitioning the user interface between a page edit state and a page preview state while maintaining the web portal session with the user. Thus, the transition may be either from the page edit state to the page preview state, or from the page preview state to the page edit state.

FIG. 2B shows one approach to transitioning a user interface between the page edit state and the page preview state. In the illustrated example, block 52 encodes a toolbar request into a first URL, and block 54 encodes state information, an author identifier, authentication information (e.g., credentials) associated with the author identifier, a previewer identifier and authentication level (but not credentials) associated with the previewer identifier into a second URL. Illustrated block 56 transmits the first and second URLs to an application server, wherein an updated content editing view and updated page view may be received at block 58. Block 60 can provide for displaying the updated content editing view and the updated page view in the UI.

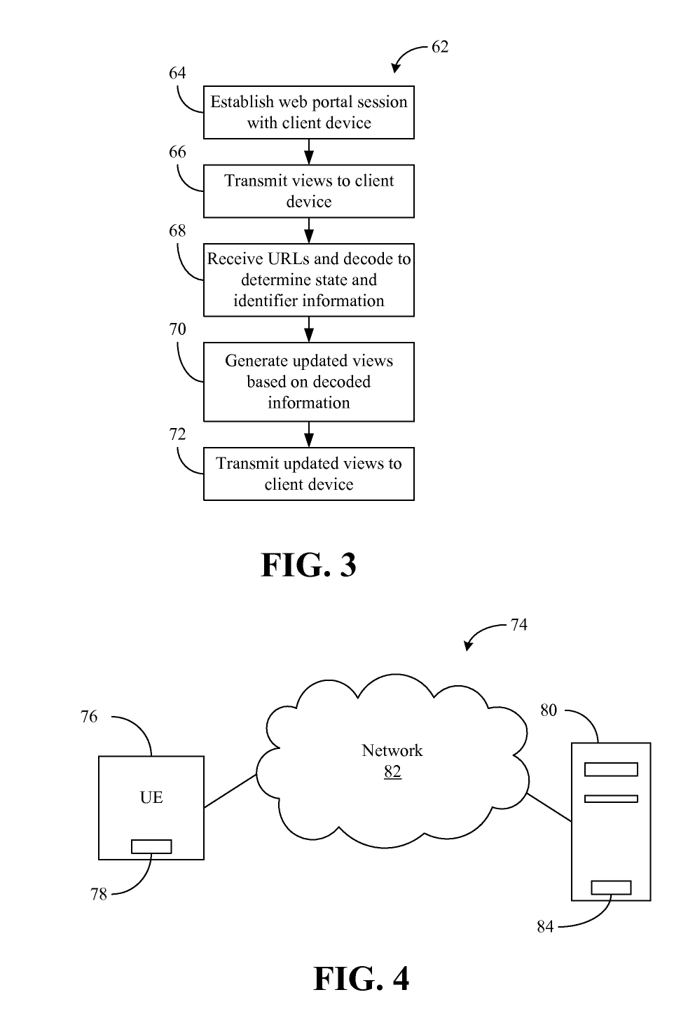

FIG. 3 shows an example of a method 62 of operating an application server. Illustrated block 64 provides for establishing a web portal session with a client device running a web content management tool, wherein page and content editing views may be transmitted to the client device at block 66. Block 68 may receive one or more web requests for URLs, and decode the URLs to determine state and identifier information. As already noted, the state information may indicate whether a page edit tab, a page preview tab, and/or various options within those tabs have been selected, edits made to the page content, collaboration information, and other project related data. Additionally, the identifier information may indicate an author identifier, authentication information associated with the author identifier, a previewer identifier, an authentication level associated with the previewer identifier, and so forth. Updated views may be generated at block 70, wherein illustrated block 72 transmits the updated views to the client device. The updated views may correspond to a transition of a user interface of the web content management tool between a page edit state and a page preview state while the web portal session is maintained with the client device.

FIG. 4 shows a networking architecture 74 in which a user equipment (UE) device 76 includes a web portal management tool 78, as already discussed. In the illustrated example, a server 80 is configured to provide web content to the UE device 76 via a network 82. The network 82 can itself include any suitable combination of servers, access points, routers, base stations, mobile switching centers, public switching telephone network (PSTN) components, etc., to facilitate communication between the UE device 76 and the server 80. In one example, the server 80 includes logic 84 that responds to web requests from the web portal management tool 78, wherein the web portal management tool 78 and the logic 84 coordinate transitions of a user interface in the web portal management tool 78 between a page edit state and a page preview state while maintaining a web portal session of a user of the UE device 76.

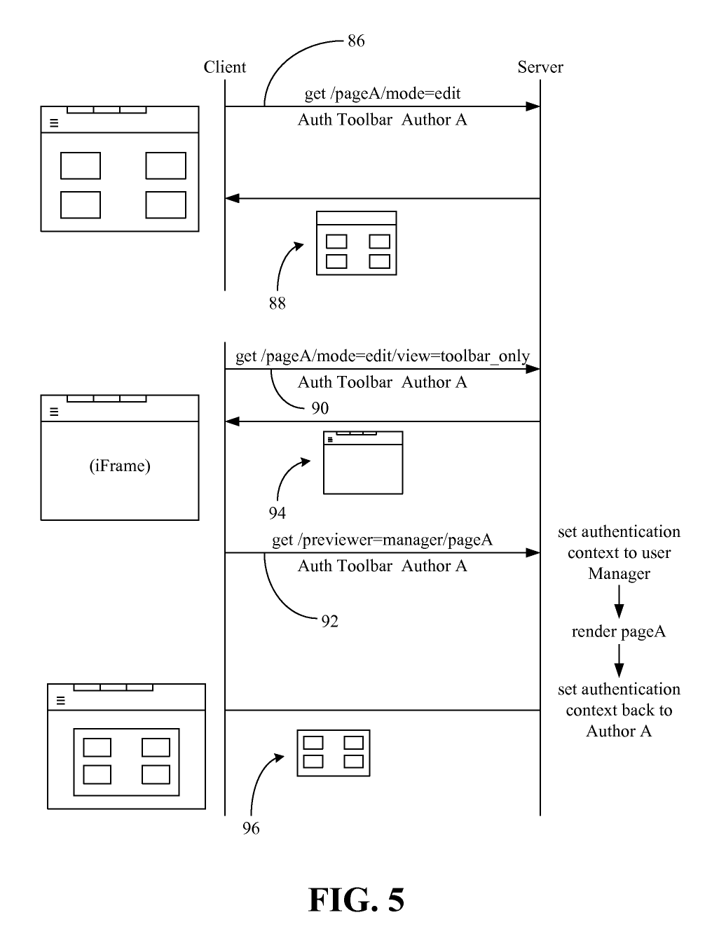

For example, FIG. 5 shows one approach to previewing pages with different user identifiers. In the illustrated example, a first request 86 gets the current page in edit mode as the current content author (“Author A”). Accordingly, the page 88 may be completely rendered in one request, including the content editing view and the page view. If the user then decides to preview the page as the user “Manager”, the result may be two requests being sent to the server. For example, a second request 90 can be used to get the toolbar 94 as the Author A content author, and a third request 92 can be used to get the page 96 rendered for the Manager user. Thus, the third request 92 may cause the current authentication context (Author A) to be replaced with the authentication context for Manager. Once the illustrated server switches the authentication contexts, the page markup can be created for Manager and returned as the page 96, wherein the server may then switch the authentication context back to that of Author A. On the client side, JavaScript code may overlay an iFrame with the toolbar 94 response to the second request 90. Accordingly, the toolbar 94 is still visible and appears to be a single page, in the illustrated example.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions. In addition, the terms “first”, “second”, etc. may be used herein only to facilitate discussion, and carry no particular temporal or chronological significance unless otherwise indicated.

Those skilled in the art will appreciate from the foregoing description that the broad techniques of the embodiments of the present invention can be implemented in a variety of forms. Therefore, while the embodiments of this invention have been described in connection with particular examples thereof, the true scope of the embodiments of the invention should not be so limited since other modifications will become apparent to the skilled practitioner upon a study of the drawings, specification, and following claims.

We claim:

1. A computer implemented method of operating a web content management tool comprising:
establishing a web portal session with a user of the web content management tool;
generating a user interface in the web content management tool during the web portal session, wherein the user interface includes a page view and a content editing view;
receiving one or more user selections via the user interface;
determining an author identifier and a previewer identifier based on the one or more user selections; and
transitioning the user interface between a page edit state and a page preview state while maintaining the web portal session with the user, wherein transitioning the user interface includes,
encoding a toolbar request into a first uniform resource locator (URL),
encoding state information, and one or more of an author identifier and a previewer identifier into a second URL,
transmitting the first URL and the second URL to an application server,
receiving an updated content editing view from the application server,
receiving an updated page view from the application server, wherein the updated page view is dependent upon the state information, and one or more of the author identifier and the previewer identifier, and
displaying the updated page view and the updated content editing view in the user interface.

2. The method of claim 1, further including encoding one or more of authentication information associated with the author identifier and an authentication level associated with the previewer identifier into the second URL, wherein the updated page view is further dependent upon one or more of the authentication information and the authentication level.

3. The method of claim 2, wherein the authentication level corresponds to a step-up authentication transition.

4. The method of claim 1, wherein the transitioning is from the page edit state to the page preview state.

5. The method of claim 1, wherein the transitioning is from the page preview state to the page edit state.

6. A computer program product comprising:
a computer readable storage medium; and
computer usable code stored on the computer readable storage medium, wherein if executed by a processor, the computer usable code causes a computer to:
establish a web portal session with a client device;
transmit a page view and a content editing view to the client device;
receive a first uniform resource locator (URL) and a second URL from the client device;
decode the first URL;
decode the second URL to identify state information, and one or more of an author identifier and a previewer identifier;
generate an updated content editing view based on the toolbar request;
generate an updated page view based on the state information and one or more of the author identifier and the previewer identifier; and
transmit the updated content editing view and the updated page view to the client device, wherein the updated content editing view and the updated page view are to correspond to a transition of a web content management tool user interface between a page edit state and a page preview state while the web portal session is maintained with the client device.

7. The computer program product of claim 6, wherein the first URL is to be decoded to identify a toolbar request.

8. The computer program product of claim 6, wherein the decode of the first URL is to further identify authentication information associated with the author identifier.

9. The computer program product of claim 6, wherein the decode of the second URL is to further identify an authentication level associated with the previewer identifier.

10. The computer program product of claim 9, wherein the computer usable code, if executed, causes a computer to conduct a step-up authentication transition of the updated page view based on the authentication level associated with the preview identifier.

11. A computer program product comprising:
a computer readable storage medium; and
computer usable code stored on the computer readable storage medium, wherein if executed by a processor, the computer usable code causes a computer to:
establish a web portal session with a user of a web content management tool;
generate a user interface in the web content management tool during the web portal session, wherein the user interface is to include a page view and a content editing view; and
transition the user interface between a page edit state and a page preview state while maintaining the web portal session with the user.

12. The computer program product of claim 11, wherein the computer usable code, if executed, causes a computer to:
encode a toolbar request into a first uniform resource locator (URL);
encode state information, and one or more of an author identifier and a previewer identifier into a second URL; and
transmit the first URL and the second URL to an application server.

13. The computer program product of claim 12, wherein the computer usable code, if executed, causes a computer to:
receive an updated content editing view from the application server;
receive an updated page view from the application server, wherein the updated page view is to be dependent upon the state information; and
display the updated page view and the updated content editing view in the user interface.

14. The computer program product of claim 13, wherein the updated page view is to be further dependent upon one or more of the author identifier and the previewer identifier.

15. The computer program product of claim 12, wherein the computer usable code, if executed, causes a computer to encode authentication information associated with the author identifier into the second URL.

16. The computer program product of claim 12, wherein the computer usable code, if executed, causes a computer to encode an authentication level associated with the previewer identifier into the second URL.

17. The computer program product of claim 16, wherein the authentication level is to correspond to a step-up authentication transition.

18. The computer program product of claim 12, wherein the computer usable code, if executed, causes a computer to:
receive one or more user selections via the user interface; and
determine the author identifier and the previewer identifier based on the one or more user selections.

19. The computer program product of claim 11, wherein the transition is to be from the page edit state to the page preview state.

20. The computer program product of claim 11, wherein the transition is to be from the page preview state to the page edit state.
